(19) United States
(12) Patent Application Publication
(10) Pub. No.: US 2007/0290075 A1
(43) Pub. Date: Dec. 20, 2007

(54) Fuel Injection Valve For Internal Combustion Engines

(76) Inventors: Dieter Junger, Stuttgart (DE); Joerg-Peter Fischer, Deizisau (DE); Thilo Kreher, Stuttgart (DE); Jens-Peter Nagel, Gerlingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/594,150

(22) PCT Filed: Jan. 19, 2005
(86) PCT No.: PCT/EP05/50201

§ 371 Date: Apr. 26, 2007

(30) Foreign Application Priority Data
Mar. 30, 2004 (DE) 10 2004 015 360.4

(51) Int. Cl. F02M 61/04

(52) U.S. Cl. 239/533.2; 123/445

(57) ABSTRACT

A fuel injection valve, having an outer valve needle cooperating with a valve seat for opening and closing at least one outer injection opening, an inner valve needle disposed in the outer valve needle and cooperating with the valve seat for opening and closing at least one inner injection opening. The fuel pressure in a control chamber that can be filled with fuel under pressure acts on the outer valve needle and the inner valve needle in such a way that a closing force in the direction of the valve seat is exerted on the inner valve needle and the outer valve needle. An inner pressure face disposed on the inner valve needle and a shoulder is disposed on the outer valve needle, which each, on being subjected to pressure, exert a hydraulic opening force, oriented counter to the closing force, on the inner valve needle and the outer valve needle. The outer valve needle is at least partly surrounded by an inflow chamber, in which fuel under pressure is always present, and the inner pressure face and the outer pressure face are always subjected to the fuel of the inflow chamber.

### PRIOR ART

The invention is based on a fuel injection valve for internal combustion engines of the kind known from German Published Patent Application DE 102 05 970 A1. An outer valve needle and an inner valve needle are disposed in the fuel injection valve and are both longitudinally displaceable; the inner valve needle is disposed in the outer valve needle. The valve needles, with a correspondingly embodied sealing face, cooperate with a valve seat and in the process each control the opening of at least one injection opening. Both on the outer valve needle and on the inner valve needle a respective sealing face is embodied, which upon subjection to fuel pressure exerts an opening force, oriented away from the valve seat, on the respective valve needle. In the housing, a control chamber is furthermore embodied, by the pressure of which a closing force oriented counter to the opening force is exerted on the outer valve needle and the inner valve needle. The control chamber can be filled with fuel under pressure, and the pressure in the control chamber can be regulated via a valve.

In the known fuel injection valve, the outer valve needle is constantly subjected to fuel that is at injection pressure. Upon pressure relief in the control chamber, the outer valve needle opens and uncovers the injection openings. Only after that is the inner valve needle and its pressure face subjected to fuel pressure, so that the inner valve needle opens after the outer valve needle.

The known fuel injection valve has the disadvantage that the fuel pressure in the intermediate chamber between the outer valve needle and the inner valve needle fluctuates periodically, so that depending on the pressure difference, the outer valve needle is pressed radially inward more or less strongly. As a result, the sliding friction between the inner valve needle and the outer valve needle is changed, which can cause increased wear or seizing of the outer valve needle on the inner valve needle. Furthermore, it is not possible to open the inner valve needle before the outer valve needle, something that is advantageous in certain operating states of the engine. The known fuel injection valve further has the disadvantage that the valve needles close one after the other. Such a successive closure of the valve needles has the effect that fuel at low pressure can pass through the injection openings to reach the combustion chamber, which leads to an increase in hydrocarbon emissions there. This is true particularly whenever the outer valve needle closes before the inner valve needle.

### ADVANTAGES OF THE INVENTION

The fuel injection valve according to the invention, having the definitive characteristics of claim 1, has the advantage over the prior art that the inner valve needle can open before the outer valve needle, which permits greater freedom of design in shaping the course of injection. Moreover, the control chamber with only one control chamber is possible. To that end, the inner valve needle and the outer valve needle are always acted upon by the fuel of the inflow chamber in such a way that the result is an opening force on the valve needles that is oriented counter to the closing force. Since a different opening pressure of the outer valve needle and the inner valve needle can be achieved via a suitable design of the respective faces, subjected to pressure, on the valve needles, it is possible by way of regulating the pressure in the control chamber for the inner valve needle to open before the outer valve needle.

Advantageous refinements of the subject of the invention are possible by means of the dependent claims. In a first advantageous feature, the intermediate chamber between the outer valve needle and the inner valve needle always communicates hydraulically with the inflow chamber. The inner pressure face is subjected to the pressure of the intermediate chamber, so that the desired opening force on the inner valve needle results. Because of the pressurized connection of the intermediate chamber with the inflow chamber, a deformation of the outer valve needle caused by pressure differences on the outside and inside of the outer valve needle is furthermore avoided, so that the friction between the outer valve needle and the inner valve needle always remains slight, and no seizing or excessive friction between these two valve needles can occur. Advantageously, this communication is established via a connecting bore which extends substantially radially in the outer valve needle, and of which preferably a plurality are distributed over the circumference of the outer valve needle.

In a further advantageous feature of the subject of the invention, a shoulder, opposite which is the inner pressure shoulder of the inner valve needle, is embodied on the inside of the outer valve needle. The axial spacing of the shoulder from the inner pressure shoulder is dimensioned such that upon contact of the inner valve needle and the outer valve needle with the valve seat, the inner pressure shoulder remains spaced apart from the shoulder. As a result, an unthrottled inflow of fuel, which is introduced into the intermediate chamber above the shoulder, to the inner injection openings is made possible. It is especially advantageous if the opening stroke of the inner valve needle and the opening stroke of the outer valve needle are adapted to one another such that the valve needles in the opening position are positioned relative to one another such that the shoulder of the outer valve needle continues to have an axial spacing from the inner pressure shoulder. As a result, an unhindered, unthrottled inflow of fuel to all the injection openings is assured. Alternatively, it may also be provided that the stroke stop of the outer valve needle is formed by the contact of the shoulder with the inner pressure shoulder. As a result, when the valve needles are open, a pressure drop in the intermediate chamber occurs, which presses the outer valve needle against the inner valve needle as a result of the compressive forces, so that the outer valve needle is prevented from leading ahead of the inner valve needle in the closing motion. A synchronous closure of the inner valve needle and outer valve needle is thus assured.

In a further advantageous feature, the axial spacing of the shoulder from the inner pressure face is dimensioned such that this spacing when the valve needles are open is shorter than the opening stroke of the inner valve needle. As a result, the inner valve needle in its closing motion carries the outer valve needle along with it and thus forces it in the direction of the valve seat. Upon the approach of the outer valve needle to the valve seat, severe throttling of the fuel stream to the outer injection openings occurs, so that the hydraulic opening force on the outer valve needle is reduced and presses the outer valve needle back into its closing position in an accelerated way. As a result, the outer valve needle takes its seat on the valve seat only a very time after the inner valve needle.

In a further advantageous feature, a valve sealing face with two sealing edges is embodied on the outer valve needle; the outer sealing edge comes to rest on the valve seat upstream and the inner sealing edge comes to rest on it downstream of the outer injection opening. It is thus assured that the outer injection opening is hydraulically closed off even when the inner valve needle is open, and no fuel can flow through this injection opening into the combustion chamber uncontrolled.

In a further advantageous feature, between the outer valve needle and the inner valve needle a control volume is embodied, which acts as a hydraulic driver. As a result, the motion of the outer valve needle can be varied by means of the inner valve needle, without causing mechanical contact between the valve needles; such contact as a rule involves increased noise and wear problems.

### DRAWINGS

In the drawings, one exemplary embodiment of the fuel injection valve of the invention is shown.

FIG. 1 is a longitudinal section through a fuel injection valve of the invention, with peripheral components shown schematically;

FIG. 2 is an enlarged view of the fuel injection valve in which because of symmetry only the right half is shown;

FIG. 3,

FIG. 4, and

FIG. 5 show various opening positions of the valve needles, the view being identical to that of FIG. 2;

FIG. 6, in an identical view to FIG. 4, shows an alternatively embodied outer valve needle,

FIG. 7 and

FIG. 8 show a further exemplary embodiment; and

FIG. 9 shows a further exemplary embodiment of the fuel injection valve.

### DESCRIPTION OF THE EXEMPLARY EMBODIMENTS

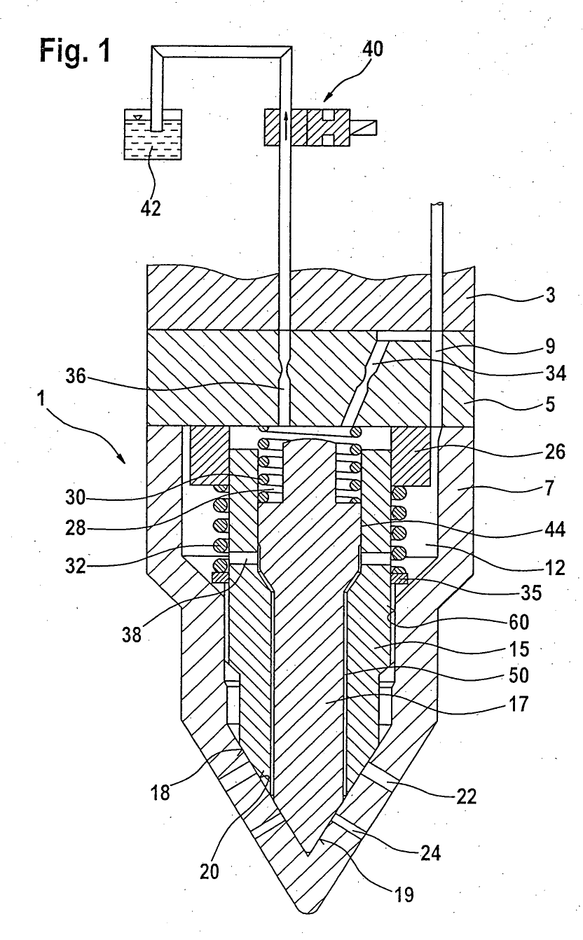

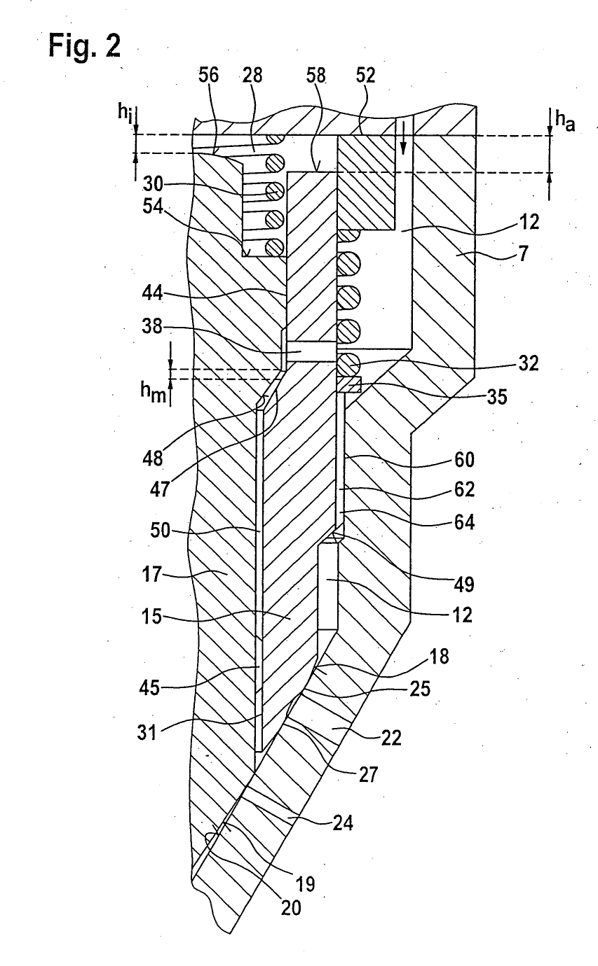

In FIG. 1, a fuel injection valve of the invention is shown in longitudinal section. The fuel injection valve 1 has a retaining body 3, shown only in part, a throttle plate 5, and a valve body 7, which are pressed against one another in that order by a device not shown. In the valve body 7, an inflow chamber 12 is embodied, which is embodied essentially as a stepped bore that is defined on its end toward the combustion chamber by a substantially conical valve seat 20. From the valve seat 20, outer injection openings 22 and inner injection openings 24 originate, which in the installed position of the fuel injection valve discharge into the combustion chamber of the engine. The outer injection openings 22, in this exemplary embodiment, have a larger diameter than the inner injection openings 24. An outer valve needle 15 is disposed in the inflow chamber 12 and is embodied as a hollow needle and thus has an inner wall 31, and on its inner end toward the valve seat, it has a substantially conical outer valve sealing face 18. A collar 62 is embodied in a middle region on the outer valve needle 15, with which collar this valve needle is guided in a guide portion 60 of the inflow chamber 12, as a result of which the outer valve needle 15 is longitudinally displaceable in the inflow chamber 12. As a result of the longitudinal motion, the outer valve needle 15, with its outer valve sealing face 18, cooperates with the valve seat 20 in such a way that the outer injection openings 22 are thereby closed or uncovered. As shown in FIG. 2, the outer valve sealing face 18 has an outer sealing edge 25 and an inner sealing edge 27, so that upon contact of the outer valve needle 15 with the valve seat 20, the outer injection openings 22 are sealed off both upstream and downstream. To enable fuel to pass in the direction of the injection openings 22, 24, ground faces 64 are embodied on the collar 62, and their cross section and number are dimensioned such that an unthrottled flow of fuel to the injection openings 22, 24 is possible.

A pistonlike inner valve needle 17 is disposed longitudinally displaceably in the outer valve needle 15 and is guided in the outer valve needle 15 by a cylindrical extension 44 remote from the valve seat. The inner valve needle 17 is furthermore guided in the outer valve needle 15 in a second guide 45, disposed toward the valve seat 20, so that an exact axial motion of the inner valve needle 17 is assured. Openings, for instance in the form of ground faces, are embodied on the guide 45 and permit a largely unthrottled fuel flow in the direction of the valve seat 20 in the intermediate chamber 50 embodied between the inner valve needle 17 and the outer valve needle 15. The inner valve needle 17, on its end toward the valve seat, has an inner valve sealing face 19, with which it cooperates with the valve seat 20 and in the process controls the opening of the inner injection openings 24 in the same way as the outer valve needle 15 controls the outer injection openings 22.

A control chamber 28, which is filled with fuel and whose pressure can be regulated, is defined by the face end 56 of the inner valve needle 17, the annular-disklike face end 58 and the outer valve needle 15, the throttle plate 5, and a sleeve 26, which is disposed on and surrounds the end, remote from the valve seat, of the outer valve needle 15. The control chamber 28 communicates, via an inflow throttle 34 embodied in the throttle plate 15, with an inflow conduit 9 by way of which the inflow chamber 12 can be filled with fuel at high pressure. In the throttle plate 5, an outflow throttle 36 is also embodied, by way of which the control chamber 28 can be made to communicate with a fuel tank 42; a low fuel pressure always prevails in the fuel tank 42. In the connecting line from the control chamber 28 to the fuel tank 42, there is a control valve 40, which opens and closes the communication. The control valve 40, in the exemplary embodiment shown, is embodied as a 2/2-way valve.

In the control chamber 28, there is an inner closing spring 30 with pressure prestressing, which is braced on a spring shoulder 54 of the inner valve needle 17 and on the other end on the throttle disk 5. A force in the direction of the valve seat 20 is exerted on the inner valve needle 17 by the inner closing spring 30. Correspondingly functioning identically to the inner closing spring 30, an outer closing spring 32 is disposed in the inflow chamber 12; it is braced by one end on the sleeve 26 and on the other end on a ring 35 that rests on the outer valve needle 15. Because of the pressure prestressing of the outer closing spring 32, a closing force in the direction of the valve seat 20 acts on the outer valve needle 15. It is thus assured by the inner closing spring 30 and the outer closing spring 32 that the outer valve needle 15 and the inner valve needle 17 remain in their closing position, unless further forces are operative, and in particular if the engine is shut off. The closing spring 32 is furthermore dimensioned such that the closing force on the outer valve needle 15 suffices, in the closing position, to seal off both sealing edges 25, 27 from the valve seat 20, even at a low pressure in the control chamber 28 and thus a low hydraulic closing force. To keep the requisite force low, only a slight wall thickness toward the inner wall 31 is provided in the region of the sealing edge 27.

A connecting bore 38 is embodied in the outer valve needle 15 and connects the inflow chamber 12, in which a high fuel pressure always prevails, with the intermediate chamber 50. Through the connecting bore 38, an inner pressure face 48 of the inner valve needle 17, which face is embodied on the side of the valve seat toward the connecting bore 38 on the inner valve needle 17, is acted upon by the fuel pressure of the inflow chamber 12. The result is a hydraulic force that points away from the valve seat 20 and is oriented counter to the force of the inner closing spring 30. Diametrically opposite the inner pressure face 48, a shoulder 47 is embodied on the inside of the outer valve needle 15; in the closing spring of the outer valve needle 15 and the inner valve needle 17, or in other words when these needles are in contact with the valve seat 20, this shoulder is axially spaced apart from the inner pressure face 48. This spacing is marked hₘ in FIG. 2. In the same way, an outer pressure face 49 is embodied on the outer valve needle 15 and is acted upon by the fuel pressure in the inflow chamber 12, as a result of which the outer valve needle 15 experiences an opening force oriented counter to the closing force of the outer closing spring 32. By means of the ground faces 64 on the collar 62, it is assured that the outer pressure face 49 is always subjected to the full fuel pressure.

The mode of operation of the fuel injection valve is as follows: At the onset of the injection, the control valve 40 is closed, and thus the communication of the control chamber 28 with the fuel tank 42 is interrupted. As a result, via the inflow throttle 34, the same pressure builds up in the control chamber 28 as in the inflow chamber 12; the inflow chamber, because of its communication via the inflow conduit 9, is always kept at a high fuel pressure. Because of the pressure in the control chamber 28, a hydraulic force results on the face end 56, remote from the valve seat, and the spring shoulder 54 of the inner valve needle 17 and the face end 58 of the outer valve needle 15. As a result of the differential pressure between the hydraulic pressure in the control chamber 28 and the pressure chamber 12 on the one hand and the combustion chamber pressure on the other, which latter pressure partly acts on the inner valve sealing face 19 and the outer valve sealing face 18, the outer valve needle 15 and the inner valve needle 17 are kept in their closing position, in addition to the force of the closing springs 30, 32. To that end, the area of the face ends 56, 58, the valve sealing faces 19, 23, and the other faces of the inner valve needle 17 and the outer valve needle 15 that are acted upon by the fuel pressure in the pressure chamber 12, are designed accordingly.

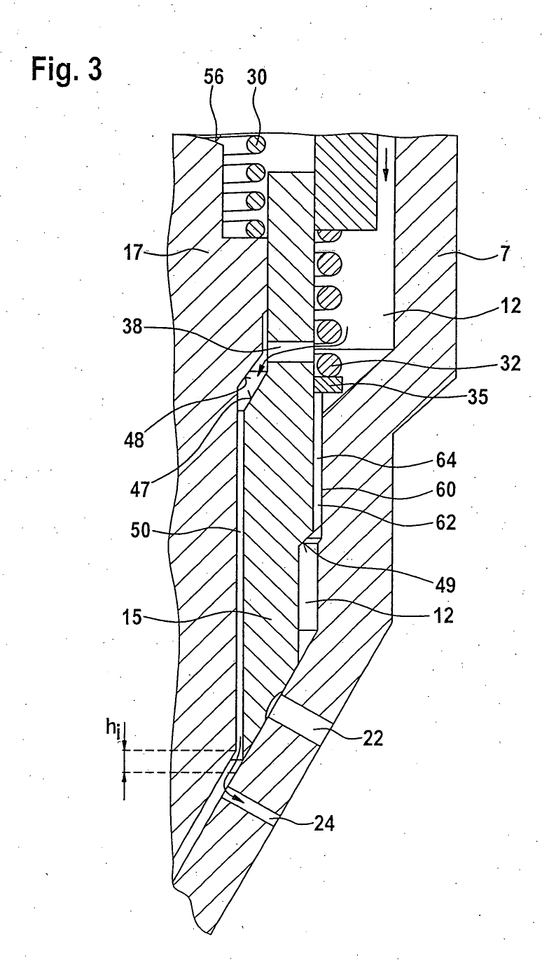

If an injection is to occur, then the control valve 40 is opened, and as a result, via the outflow throttle 36, fuel flows out of the control chamber 28, and the fuel pressure there drops. As a result, the hydraulic force on the face end 56 of the inner valve needle 17 decreases, so that the inner valve needle 17, driven by the hydraulic forces on the inner pressure face 48 and on parts of the inner valve sealing face 19, lifts from the valve seat 20, until, after an opening stroke hᵢ has been executed, the face end 56 comes to rest on the throttle disk 5. This position of the fuel injection valve is shown in FIG. 3. The fuel travel distance from the inflow chamber 12 through the connecting bore 38 and the intermediate chamber 50 and between the inner valve sealing face 19 and the valve seat 20 through to the inner injection openings 24 is opened as a result, so that a fuel injection takes place through the inner injection openings 24. The sealing edges 25, 27 embodied on the outer valve sealing face 18 seal off the outer injection openings 22, as a result of which they remain closed, as before.

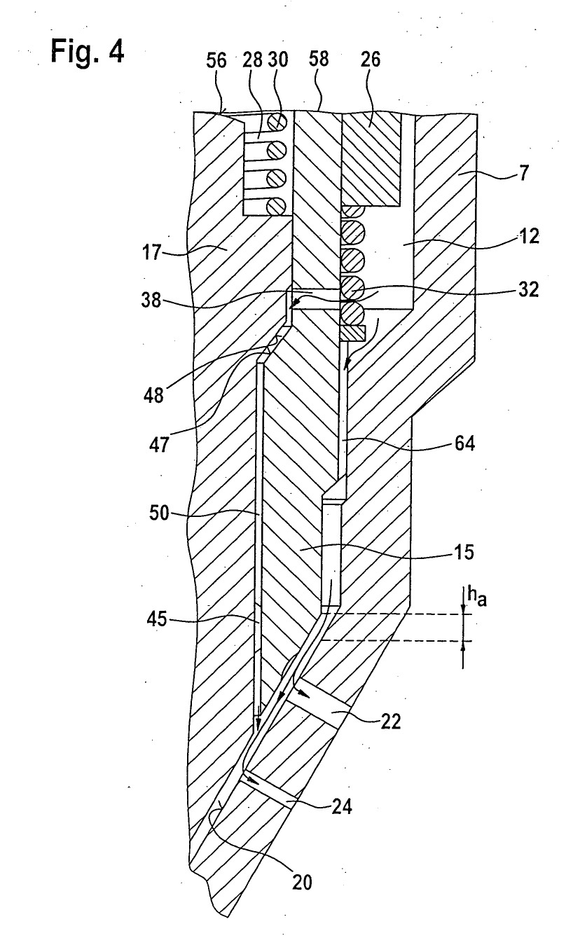

If the fuel pressure in the control chamber 28 drops further, then finally the opening force of the outer valve needle 15 is reached, that is, the pressure at which the hydraulic closing force on the face end 58 and on the shoulder 47 as well as the force of the closing spring 30 are in total less than the sum of the hydraulic opening forces on the outer pressure face 49 and on the partial area, subjected to fuel, of the outer valve sealing face 18. The outer valve needle 15 lifts from the valve seat 20 and executes an opening stroke hₐ, until it comes with its face end 58 into contact with the throttle disk 5. This position of the fuel injection valve is shown in FIG. 4. The opening stroke in the outer valve needle 15 is dimensioned such that in its opening position, an axial spacing remains between the shoulder 47 and the inner pressure face 48. By a closure of the control valve 40, the outer valve needle 15 can also reach its closing position again sooner, as a result of which less fuel reaches the combustion chamber. In this opening position, fuel flows on the one hand through the connecting bore 38 and the intermediate chamber 50 and through ground faces along the second guide 45 to the inner injection openings 24, and on the other hand, fuel from the inflow chamber 12 flows through the ground faces 64 between the outer valve sealing face 18 and the valve seat 20 through the outer injection openings 22, so that now fuel is injected into the combustion chamber through all the injection openings. By the inflow of fuel via both the inflow chamber 12 and the intermediate chamber 50, all the injection openings 22, 24 are optimally supplied with fuel, so that with full pressure, a large quantity of fuel can be introduced into the combustion chamber in a short time.

To terminate the injection, the control valve 40 is closed, so that via the replenishing fuel flowing through the inflow throttle 34, the fuel pressure in the control chamber 28 rises again. The valve needles begin their closing motion, after exceeding the respecting closing pressure in the control chamber 28, and the closing pressure of the outer valve needle 15 is reached earlier than that of the inner valve needle 17. The reason for this is on the one hand that the force of the outer closing spring 32 is greater, and on the other that the hydraulic compressive forces on the outer valve sealing face 18 are less, because of the throttling of the fuel flow from the inflow chamber 12 in the direction of the outer injection openings 22, than the hydraulic compressive forces on the inner valve needle 17. During the closing motion of the outer valve needle 15, the pressure in the control chamber 28 remains at least approximately constant, since the fuel inflow via the inflow throttle 34 and the enlargement of the control chamber 28 compensate for one another. As the outer valve needle 15 approaches increasingly closer to the valve seat 20, the throttling at the outer valve sealing face 18 increases, resulting in an accelerated closure of the outer valve needle 15. The position of the outer valve needle 15 and the inner valve needle 17 relative to one another, at which position the outer valve needle 15 has already taken its seat on the valve seat 20 but the inner valve needle 17 is still spaced apart somewhat from the valve seat 20, is in turn shown in FIG. 3.

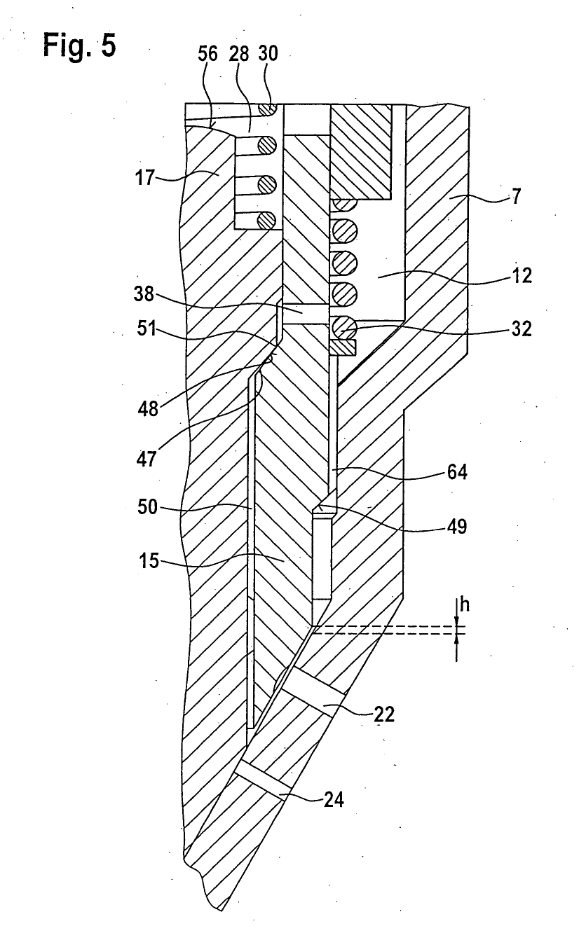

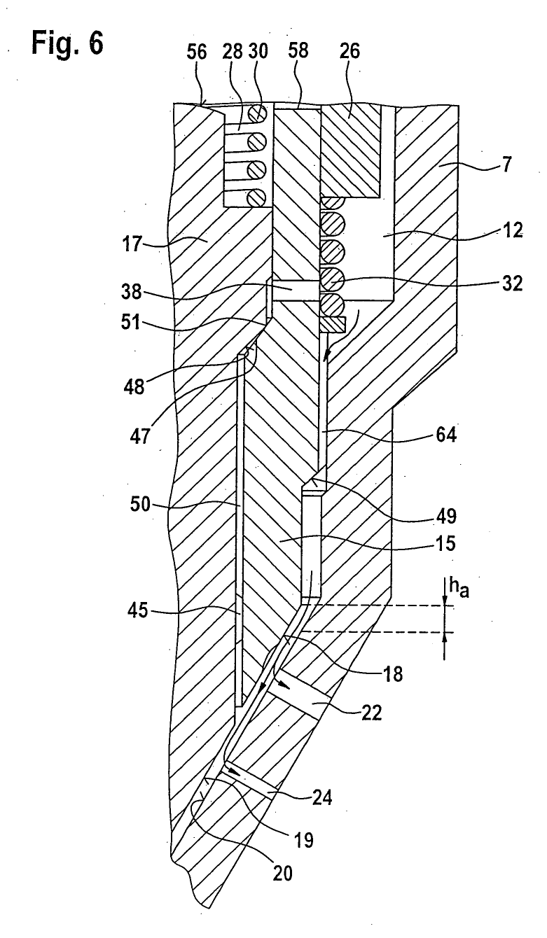

In FIG. 5 and FIG. 6, an alternative embodiment of the inner pressure face 48 and of the shoulder 47 is shown. Both the shoulder 47 and the inner pressure face 48 are preferably embodied as conical faces, which here, however, do not have the same opening angles, as shown in FIGS. 2, 3 and 4, but instead, the opening angle of the inner pressure face 48 is greater than the opening angle of the shoulder 47. The axial association between the inner pressure face 48 and the shoulder 47 on the one hand and the face end 58 of the outer valve needle 15 on the other is designed such that a gap always remains between the face end 58 and the throttle plate 5. This situation is shown in FIG. 6. When in the opening motion of the outer valve needle 15 the shoulder 47 rests on the inner pressure face 48, a sealing edge 51 forms there, as a result of which a lower pressure is established in the intermediate chamber 50, in accordance with the pressure conditions in the region of the valve seat 20. Because of the now lower pressure in the intermediate chamber 50, both relative to the pressure in the inflow chamber 12 and relative to the pressure in the control chamber 28, a greater closing force results on the inner valve needle 17 in the closing operation. Conversely, a compressive force oriented counter to the closing motion acts on the outer valve needle 15 on the outer pressure face 49, which is subjected to the pressure of the inflow chamber 12, so that the closing motion of the outer valve needle 15 is correspondingly delayed. This prevents the outer valve needle 15 from leading in the closing motion and prevents the inner valve needle 17 from closing later than the outer valve needle; the latter option is otherwise favored, because of the always greater seat throttling and the resultant pressure reduction at the outer valve sealing face 18.

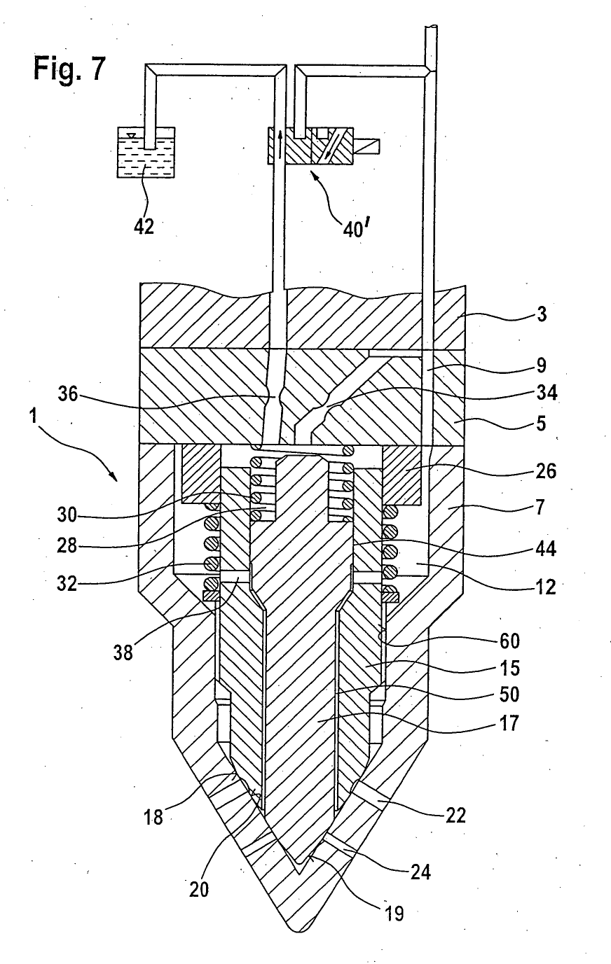

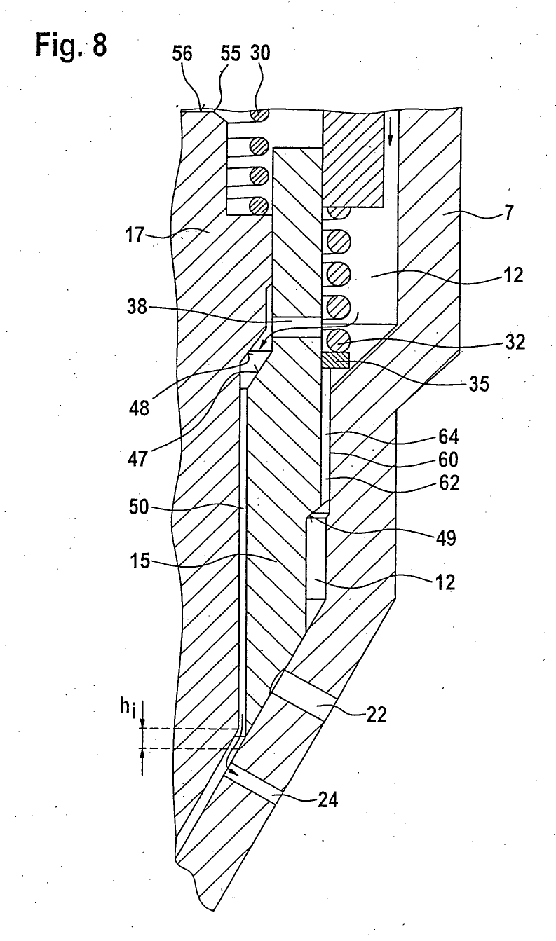

In FIG. 7 and FIG. 8, a further exemplary embodiment is shown; below, only the differences from the above exemplary embodiments will be addressed. The inflow throttle 34 here is disposed in the throttle disk 5 in such a way that the inner valve needle 17 partly or completely closes the inflow throttle 34 upon contact with the throttle plate 5. The face end 56 of the inner valve needle 17 is embodied as a face parallel to the throttle plate 5 and is provided with a bite edge 55, which assures adequate sealing at this point. Because of the partial or complete prevention of the fuel inflow through the inflow throttle 34 into the control chamber 28, the pressure in the control chamber 28 drops very rapidly, because of the outflow through the outflow throttle 36, until a control chamber pressure is reached at which the outer valve needle 15 also opens. It is therefore possible to open the outer valve needle 15 already soon after the complete opening of the inner valve needle 17. Moreover, the difference between the opening pressures of the inner valve needle 17 and the outer valve needle 15 can be increased, without causing a major time lag between the instant of opening of the inner valve needle 17 and that of the outer valve needle 15. To control the closing operation, a 3/2-way valve is provided here as the control valve 40′; in the first switching position, it connects the outflow throttle 36 with the fuel tank 42, while in the second switching position the outflow throttle communicates with the inflow conduit 9. In the closing operation, the control valve 40′ is put in its second switching position, so that via the outflow throttle 36, fuel flows into the control chamber 28. As a result of this inflow, the control chamber pressure can rapidly be increased, even if the inflow throttle 34 is completely sealed off by the inner valve needle 17. Immediately after the inner valve needle 17 lifts from the throttle disk 5, fuel flows through both the inflow throttle 34 and the outflow throttle 36 into the control chamber 28, so that the closing operation takes place with reduced throttling and thus at a higher speed.

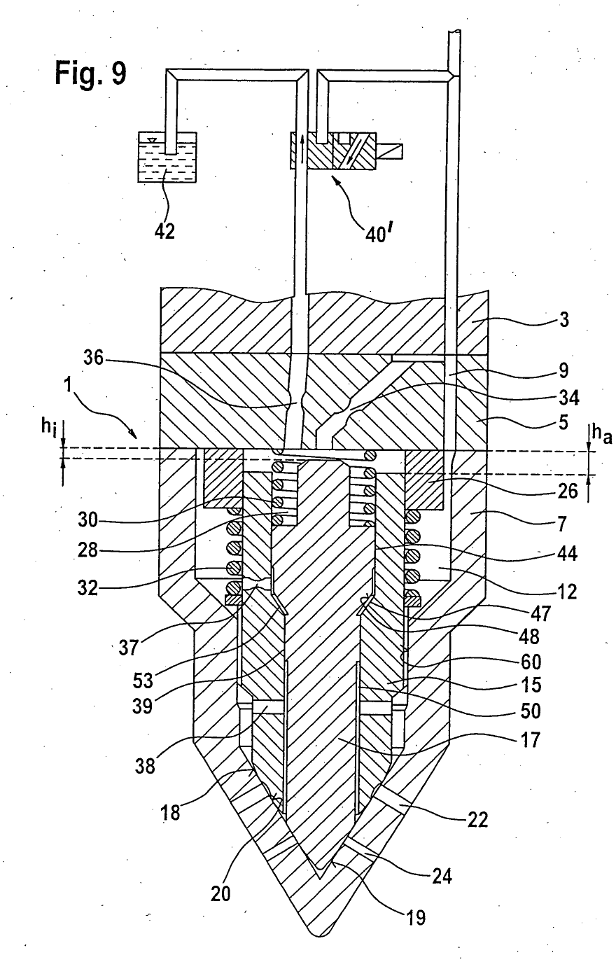

In FIG. 9, a further exemplary embodiment is shown, in which the cooperation of the inner valve needle 17 and the outer valve needle 15 is effected hydraulically. The shoulder 47 and the inner pressure face 48, together with the cylindrical extension 44 and a further cylindrical extension 39, embodied on the inner valve needle 17, enclose a control volume 53, which communicates with the inflow chamber 12 through a throttle bore 37 embodied in the outer valve needle 15 and serves as a hydraulic driver. Both the cylindrical extension 44 and the further cylindrical extension 39 seal off the control volume 53 adequately here. As a result of the control volume 53, a hydraulic damping of the relative motion between the inner valve needle 17 and the outer valve needle 17 can be generated, which results in a reduced opening speed of the inner valve needle 17, because of the rapidly falling pressure in the control volume 53 and the resultant absence of an opening force on the inner pressure face 48. The connecting bores 38 should be disposed between the further cylindrical extension 39 and the valve seat 20, in order to assure an unthrottled inflow to the intermediate chamber 50. The instant of opening of the outer valve needle 15 should advantageously be placed at an instant after the termination of the opening of the inner valve needle 17, which can be assured in combination with the exemplary embodiment shown in FIG. 7 and FIG. 8. As a result, the opening motion of the outer valve needle 15 is likewise damped, without a sudden opening taking place.

As a function of the opening duration of the control valve 40′, the outer valve needle 15 executes a partial stroke of the total stroke hₐ of the outer valve needle 15, as a result of which the opening duration of the outer valve needle 15 and of the inner valve needle 17 is lengthened, and the injection quantity increases proportionately. If the control valve 40′, which is likewise embodied here as a 3/2-way valve, is closed, the pressure in the control chamber 28 increases, and as a result the outer valve needle 15, because of the greater seat throttling, leaves its seat first, yet the inner valve needle 17, because of the pressure reduction in the control volume 53, which enlarges as a result of the motion of the outer valve needle 15, and because of the attendant diminishing opening force on the inner pressure face 48, is carried along in the direction of the valve seat 20. The closing order between the inner valve needle 17 and the outer valve needle 15 is dependent on the triggering duration and on the adaptation between the stroke of the inner valve needle 17 and the stroke of the outer valve needle 15. The stroke ha of the outer valve needle 15 should preferably be adapted to the stroke hᵢ of the inner valve needle 17 in such a way that at maximum injection quantity, the inner valve needle 17 and the outer valve needle 15 close simultaneously, so that the shortest possible injection duration is made possible for the desired injection quantity.

In designing the control volume 53, it is advantageous if the outer valve needle 15, at the maximum injection quantity, does not come into contact with a fixed stop. The outer valve needle 15 throttles the fuel flow at the onset of its opening stroke motion. If the outer valve needle 15 moves out of this throttled range, the fuel flow from the inflow chamber 12 to the injection openings 22, 24 is largely independent of the stroke of the outer valve needle 15. A stop can thus be dispensed with, and the pressure in the control chamber 28 is thus increased again in such a timely fashion that the outer valve needle 15 remains in the ballistic mode of operation. This also causes a reduction in noise, since the stop of the outer valve needle 15 is omitted.

A complicated production of a targeted opening stroke of the outer valve needle 15 is furthermore unnecessary. An unsteady motion caused by bouncing on the stop, which adversely affects the characteristic curve of the fuel quantity, can also be avoided.

1-18. (canceled)

19. A fuel injection valve for internal combustion engines, the injection valve having an outer valve needle which by means of a longitudinal motion cooperates with a valve seat for opening and closing at least one outer injection opening an inner valve needle disposed in the outer valve needle and which by means of its longitudinal motion cooperates with a valve seat for opening and closing at least one inner injection opening a control chamber which can be filled with fuel under pressure, the fuel pressure acting on the outer valve needle and the inner valve needle in such a way that as a result, a closing force in the direction of the valve seat is exerted on the inner valve needle and the outer valve needle and an inflow chamber which at least partly surrounds the outer valve needle and can be filled with fuel under pressure, the improvement wherein an opening force oriented counter to the closing force is applied to both the inner valve needle and the outer valve needle by means of the fuel pressure in the inflow chamber.

20. The fuel injection valve as defined by claim 19, further comprising an intermediate chamber between the outer valve needle and the inner valve needle which intermediate chamber is always in hydraulic communication with the inflow chamber.

21. The fuel injection valve as defined by claim 20, further comprising an inner pressure face embodied on the inner needle, which inner pressure face is subjected to the pressure in the intermediate chamber.

22. The fuel injection valve as defined by claim 20, further comprising at least one connecting bore in the outer valve needle establishing communication of the intermediate chamber with the inflow chamber.

23. The fuel injection valve as defined by claim 21, further comprising a shoulder on the inside of the outer valve needle, which shoulder is located opposite the inner pressure face of the inner valve needle, and which is axially spaced apart from the inner pressure face upon contact of the inner valve needle and the outer valve needle with the valve seat.

24. The fuel injection valve as defined by claim 23, wherein the inner valve needle, after lifting from the valve seat and after executing an opening stroke, comes with its face end into contact with a fixed stop, and wherein the outer valve needle after executing an opening stroke comes with its face end into contact with a fixed stop, and wherein the opening strokes are dimensioned relative to one another such that the shoulder of the outer valve needle remains spaced apart from the inner pressure face when the outer valve needle and the inner valve needle are in their opening position.

25. The fuel injection valve as defined by claim 23, wherein the inner valve needle, after lifting from the valve seat and after executing an opening stroke, moves into an opening position and with its face end comes into contact with a fixed stop, and wherein the shoulder of the outer valve needle in its opening stroke comes into contact with the inner pressure face.

26. The fuel injection valve as defined by claim 23, wherein the inner valve needle in its closing motion toward the valve seat moves the opened outer valve needle in the closing direction by means of contact with the shoulder.

27. The fuel injection valve as defined by claim 24, wherein the inner valve needle in its closing motion toward the valve seat moves the opened outer valve needle in the closing direction by means of contact with the shoulder.

28. The fuel injection valve as defined by claim 25, wherein the inner valve needle in its closing motion toward the valve seat moves the opened outer valve needle in the closing direction by means of contact with the shoulder.

29. The fuel injection valve as defined by claim 24, further comprising an inflow throttle controlling filling of the inflow chamber with fuel under pressure, and wherein the inner valve needle closes the inflow throttle upon contact with the fixed stop.

30. The fuel injection valve as defined by claim 25, further comprising an inflow throttle controlling filling of the inflow chamber with fuel under pressure, and wherein the inner valve needle closes the inflow throttle upon contact with the fixed stop.

31. The fuel injection valve as defined by claim 23, wherein the inner pressure face and the shoulder are embodied conically, and wherein the conical faces have different opening angles, so that the shoulder can come into contact with a sealing edge on the inner pressure face in such a way that the communication of the inflow chamber with the intermediate chamber via the connecting bore is disrupted.

32. The fuel injection valve as defined by claim 19, wherein the valve seat is embodied substantially conically, wherein at least one outer injection opening and one inner injection opening originate at the valve seat, and wherein the outer valve needle controls the outer injection openings, and the inner valve needle controls the inner injection openings.

33. The fuel injection valve as defined by claim 32, wherein the outer valve sealing face on the outer valve needle is shaped such that upon contact of the outer valve needle with the valve seat the outer injection openings are sealed off both upstream and downstream.

34. The fuel injection valve as defined by claim 30, wherein the outer valve sealing face on the outer valve needle comprises an outer sealing edge and an inner sealing edge, of which the outer sealing edge comes into contact with the valve seat upstream of the outer injection openings and the inner sealing edge comes into contact with the valve seat downstream of the outer injection openings whereby the outer injection openings are sealed off in both flow directions.

35. The fuel injection valve as defined by claim 19, further comprising an inflow throttle providing fluid communication between the control chamber and an inflow conduit an outflow conduit providing fluid communication between the control chamber and a fuel tank, and a control valve disposed in the outflow conduit and operable to open or close the outflow conduit.

36. The fuel injection valve as defined by claim 19, wherein the control chamber can be made to communicate with a fuel tank via an outflow conduit, and wherein the outflow conduit the fuel tank and the inflow conduit communicate with a control valve in such a way that the outflow conduit communicates with the fuel tank in a first switching position of the control valve and with the inflow conduit in a second switching position.

37. The fuel injection valve as defined by claim 19, further comprising a first cylindrical extension and a further cylindrical extension embodied on the inner valve needle and axially spaced apart from one another, the first and second cylindrical extensions being embodied such that at the cylindrical extensions, a hydraulic sealing is effected at a place between the inner valve needle and the outer valve needle, and by means of the hydraulic extensions a control volume is defined which communicates with the inflow chamber via a throttle bore.

38. The fuel injection valve as defined by claim 37, wherein the control volume and the throttle bore are designed such that the outer valve needle at the maximum injection quantity of the fuel injection valve, does not come into contact with a fixed stop.

39. The fuel injection valve as defined by claim 38, wherein the closing speeds of the outer valve needle and inner valve needle are adapted to one another such that at the maximum injection quantity of the fuel injection valve, upon their closing motion, they come into contact with the valve seat simultaneously.
